(19) United States
(12) Patent Application Publication
(10) Pub. No.: US 2003/0200150 A1
(43) Pub. Date: Oct. 23, 2003

(54) Systems and methods for facilitating negotiations for supply chain control

(75) Inventors: Brian J. Westcott, Menlo Park, CA (US); Peter S. Manta, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Elnnovate, Inc., Menlo Park, CA

(21) Appl. No.: 10/125,688

(22) Filed: Apr. 17, 2002

(51) Int. Cl. G06F 17/60

(52) U.S. Cl. 705/26

(57) ABSTRACT

Improved systems and methods for facilitating negotiations and managing orders for materials between buyers and sellers are provided. For example, a manufacturer can order materials from numerous suppliers using techniques of the present invention. Suppliers can access requisitions from a manufacturer. The requisitions may contain a quantity of materials and delivery dates. Systems of the present invention can identify the critical suppliers that cannot meet the requested requirements. The system can then renegotiate orders with all of the other suppliers so that the materials needed for the product arrive according to a revised schedule. The system can also respond to changes in the demand for a product by renegotiating orders with the suppliers. Systems and methods of the present invention reduce the carrying costs associated with inventories of materials.

### BACKGROUND OF THE INVENTION

The present invention relates to systems and methods for facilitating negotiations for supply chain control, and more particularly, to improved techniques for facilitating negotiations between buyers and sellers in a supply chain.

Original equipment manufacturers (OEMs) make products that are sold to customers. OEMs often manufacture products that are custom made to meet the requirements of particular customers. When a customer places an order for a product with an OEM, the customer usually indicates that it needs to receive a specific quantity of a product within a given time.

OEMs usually purchase materials from suppliers that are needed to build the OEM's products. OEMs of complex devices (such as semiconductor fabrication equipment) often purchase hundreds or even thousands of different types of materials from suppliers that are needed to manufacture their products. Hundreds or thousands of purchase order transactions with suppliers can be difficult to manage effectively to meet a production schedule that is designed to satisfy customer's requirements. In addition, the suppliers may need to purchase materials from other suppliers to supply the materials requested by the OEM.

Usually, the OEM's product cannot be manufactured until all or most of the materials needed to build the product have arrived. If one or more of an OEM's suppliers cannot deliver the materials within the time requested by the OEM, the OEM must delay production of the product. Materials provided by some suppliers may arrive well in advance of materials provided by other suppliers. Because production typically cannot start until all of the necessary materials have arrived, the OEM must pay the carrying costs of large quantities of materials until all of the materials have arrived. OEMs often need to hold materials bought from some suppliers for a substantial period of time (e.g., 4-6 months) before all of the materials that are needed have arrived and production can begin.

The carrying costs for an inventory of materials can be substantial over a period of time. For example, the cost to carry materials bought from suppliers is often between 30-36% annually of the total value of inventory held by an OEM. The inventory carrying costs can include finance charges (e.g., on loans secured to buy materials that cannot be repaid until the products are sold), security (preventing theft), storage space, tracking materials, and maintaining the integrity of parts and materials.

It would therefore be desirable to provide improved techniques for facilitating negotiations between OEMs and suppliers that would reduce the duration that OEMs need for inventory of materials bought from suppliers that arrive at different times.

### BRIEF SUMMARY OF THE INVENTION

The present invention provides systems and methods for facilitating negotiations to purchase materials between buyers and sellers in a supply chain. The present invention reduces the inventory of materials that a buyer has to carry until the materials can be used to build a product. For example, using techniques of the present invention, a manufacturer can order materials from numerous suppliers. Suppliers can access requisitions for the materials stored in a database that may include a quantity, a price, and delivery dates.

Each supplier reviews a requisition and determines if it can meet the manufacturer's requirements in terms of, for example, quantity, price, and delivery time. A supplier may agree to all of the terms of manufacturer's requisition if it has the available capacity. If a supplier cannot meet the manufacturer's requirements, the supplier may propose an alternate supply schedule or alternative price.

The manufacturer can accept a supplier's alternate schedule or propose a different schedule. Negotiations continue using the system of the present invention until an agreement has been reached with each supplier. The suppliers can also place requisitions to their suppliers to obtain materials using the present invention.

The system of the present invention also identifies suppliers that cannot meet the requirements requested by the manufacturer. The suppliers of certain materials may be particularly important. These suppliers become critical suppliers if late delivery of their materials will delay the build cycle of the product.

The manufacturer may attempt to negotiate the earliest possible delivery schedule with the critical supplies. The purchase orders with the other suppliers may then be renegotiated so that all the materials needed for the product arrive according to a revised schedule that reduces the manufacturer's carrying costs associated with the materials. The present invention greatly reduces the amount of time that manufacturers have to carry an inventory of materials before production on a product can begin.

One embodiment of the present invention comprises a method for facilitating negotiations for purchasing materials between a buyer and a plurality of sellers. The method comprises calculating a first plan for a set of materials based on a demand for a product, wherein the first plan indicates at least first quantities of the materials needed to build the product. The method also comprises releasing a portion of the first plan to each of the plurality of sellers. The method also comprises receiving data relating to the first plan for the set of materials from at least one of the plurality of sellers. The method further comprises calculating a second revised plan for the set of materials in response to the data from the seller. The second revised plan indicates new data compared to the first plan. The new data relates to quantities of the materials, delivery dates for the materials, or a price for the materials.

### BRIEF DESCRIPTION OF THE DRAWINGS

FIG. 1 is a flow chart illustrating communication links between a customer, a manufacturer, and suppliers;

FIGS. 2A-2B are flow charts illustrating the process of facilitating negotiations for an order for materials among a customer, a manufacturer, and a supplier;

FIG. 3 illustrates an interactive interface showing an example of an inventory of materials;

FIG. 4 illustrates an interactive interface of purchasing lead times for materials;

FIG. 5 illustrates an interactive interface that provides a buyer with an opportunity to enter requisition information;

FIG. 6 illustrates an interactive interface that provides a seller with an opportunity to enter alternative information in response to a buyer's requisition;

FIG. 7 illustrates a screen that displays a list of orders for materials; and

FIG. 8 illustrates diagram of how requisitions are distributed to suppliers.

### DETAILED DESCRIPTION OF THE INVENTION

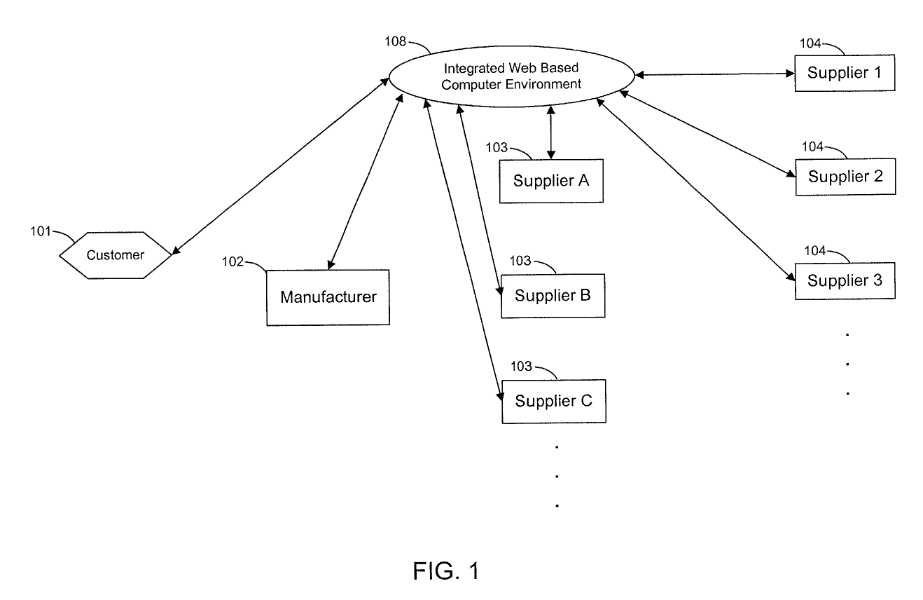

FIG. 1 is a system diagram of a preferred embodiment of the present invention that includes a customer, a manufacturer (OEM), and a chain of suppliers. A customer 101 can order products from a manufacturer 102. Manufacturer 102 requires a set of materials to build the products requested by customer 101. Manufacturer 102 can order the required materials from a plurality of suppliers 103. Each of suppliers 103 can order materials from their own suppliers that are needed to build the materials ordered by manufacturer 102. For example, Supplier A can order materials from suppliers 104. In the same fashion, suppliers 104 can order materials from their own set of suppliers that are needed to build their materials. The system of ordering materials from suppliers illustrated in FIG. 1 is called a supply chain.

Records that indicate the demand for the manufacturer's product can be stored in one or more databases. The databases may store orders from customers and data that indicates a forecast demand for a product. The databases can reside on integrated web based computer environment 108. Integrated web based computer environment (IWBCE) 108 may include, for example, one or more linked web-enabled servers.

Customer 101, manufacturer 102, and suppliers 103 can access databases that store information used by the collaborative supply chain control system through IWBCE 108 using 10 the Internet or other communications media. Customer 101, for example, can connect to IWBCE 108 to place a purchase order for products from manufacturer 102. Customer 101 can access a web server associated with IWBCE 108 through the Internet. Then, customer 101 downloads web pages onto a web browser that provides a user interface for the customer to place the purchase order. The web server provides an interface that allows the customer to enter a product type, a quantity of products, and requested delivery dates or a delivery schedule. This information is then stored in a database and added to the total demand for that product.

Records that indicate the materials needed from suppliers 103 to build enough products to meet the demand for a product can also be stored on a database. This database may also reside on a server associated with IWBCE 108. Well-known software produces a materials schedule that lists the requirements for each item of material that are needed to build enough products. The materials schedule specifies the materials that need to be obtained from the suppliers and when each set of materials needs to arrive so that the products can be built by the customer's deadline. The materials schedule takes into account the lead time that the manufacturer needs to build the products once particular materials have arrived. The materials schedule enables the products can be built by the customer's deadline.

Once all of the material requirements have been determined and the suppliers have been selected, each supplier 103 is notified that manufacturer 102 has submitted a requisition for materials to that supplier. The notifications can, for example, be in the form of e-mail messages, faxes, phone calls, or any other type of messages to each of suppliers 103. Suppliers 103 can access details about the requisitions from databases that reside on IWBCE 108. For example, a supplier 103 can download the requisition information onto a web browser from a web server associated with IWBCE 108. Suppliers 103 can agree to deliver the materials as requested or enter different quantities, prices, and/or delivery dates for the materials.

Negotiations can continue between manufacturer 102 and suppliers 103 until a materials schedule is finalized for all of the materials. Software updates the materials schedule in response to input from suppliers 103 and manufacturer 102. Once the materials schedule has been finalized, manufacturer 102 can then provide the customer with a final customer order delivery schedule that indicates when the products will be delivered to customer 101.

Suppliers 103 may purchase materials from other suppliers to make their own materials. Supplier A, for example, can submit orders to purchase required materials to suppliers 104 in accordance with the present invention. Customer orders for supplier A's products are logged into a database. This database may also reside on a server or servers (e.g., a web server) associated with IWBCE 108. Software then calculates a total demand for supplier A's products and calculates a materials schedule that outlines the requirements for each material that are needed to build supplier A's products.

Suppliers 104 are then notified that supplier A wants to purchase materials from them. Suppliers 104 can access databases maintained on IWBCE 108 to view requisition information for the materials. Suppliers 104 can agree to deliver the materials as requested or enter different quantities, prices, and/or delivery dates for the materials into the databases. Negotiations can continue between supplier A and suppliers 104 until a final materials schedule is agreed upon. The present invention can also support purchase orders for three or more suppliers in a supplier chain linked to manufacturer 102.

In one embodiment of the present invention, a third party provides the collaborative supply chain control system to manufacturers and suppliers as a service. For example, a third party can operate and maintain IWBCE 108. IWBCE 108 can store the supply, delivery, and inventory information for multiple manufacturers and suppliers. The manufacturers and suppliers that use databases maintained on IWBCE 108 do not have to be related. For example, manufacturer A may order materials from suppliers in group B, and manufacturer C may order materials from suppliers in group D. There may or may not be overlap between the suppliers in group B and group D.

The present invention provides a system for facilitating the negotiation of purchase orders between customers, manufacturers, and suppliers. The systems of the present invention can continuously update a materials schedule for the delivery of materials needed to build a product and a production schedule to build the product. The present invention can identify the suppliers that cannot meet the requirements needed to build a product by a customer deadline. Purchase orders with these critical suppliers can be negotiated until terms of the orders are agreed upon by the OEM and the critical suppliers. The system of the present invention makes it easier for OEMs and suppliers to agree upon the most advantageous supply and delivery schedule for each entity.

Once the terms of orders with the critical suppliers have been finalized, the delivery dates for the materials ordered from the remaining suppliers can be renegotiated so that the time that OEMs must inventory materials before they can be used is reduced. The present invention greatly reduces the cost associated with carrying an inventory by reducing the time between arrival of the materials and manufacture of the product. Therefore, the present invention reduces the quantity of materials that an OEM must hold at any given time.

An OEM often needs to send hundreds or thousands of orders to suppliers to purchase the materials needed to build the products requested by the customer. The orders to the suppliers specified a delivery schedule tailored to meet the customer's deadline.

In the prior art, if one or more suppliers cannot supply the materials in the time requested, the OEM has to individually renegotiate the hundreds or thousands of orders with all of the other suppliers to avoid accumulating a backlog of unwanted inventory. The OEM renegotiates the supplier orders so that the OEM does not have to carry a large inventory of materials for several months before the materials arrive from the suppliers that cannot meet the original schedule. While the OEM is carrying materials that arrive from some suppliers on-time, the OEM may not be able to start manufacturing the products until materials arrive from particular suppliers.

Individually renegotiating orders with hundreds or thousands of supplier through faxes, phone calls, and e-mails typically consumes an inordinate time. In addition, it can be an extremely complex process for human beings to determine the most advantageous delivery schedule that takes into account the capacity of a multitude of suppliers. As a result, OEMs typically must carry a large inventory of materials that arrive well before production can begin (e.g., several months). Therefore, there is a need for a computer system that can communicate directly with suppliers to quickly and efficiently negotiate the most advantageous and cost effective delivery schedule for the materials.

The system of the present invention can identify the critical suppliers that cannot meet the OEM's delivery schedule. The OEM's delivery schedule may take into account that certain materials are needed before others in the production process. The system negotiates with the critical suppliers to determine delivery terms that fall within each of the supplier's capacity.

The system then facilitates renegotiating the orders with the other suppliers so that the materials arrive according to a revised schedule that minimizes inventory carrying costs. This typically requires pushing out the delivery of these materials to a later date closer to the delivery dates of materials from the critical suppliers. The system facilitates negotiating orders with hundreds or thousands of suppliers in a fast and efficient manner with minimal human intervention (or even no human intervention). Thus, the present invention provides assistance in negotiating the terms of large numbers of orders that would be difficult for a human being to handle manually.

The present invention automatically determines a revised delivery schedule for each supplier based on the constraints imposed by the critical suppliers and allows each supplier to access the updated delivery schedule. Also, if a customer cancels an order, a customer changes the terms of an order, or the forecast demand for a product changes, the present invention automatically calculates a revised customer demand schedule for the product and makes the updated materials requirements and delivery dates available to each supplier. Negotiations can then take place between the OEM and the suppliers until the most cost effective delivery schedule is achieved. The present invention makes it possible for OEMs to substantially reduce costs associated with carrying inventories of materials by quickly and efficiently updating orders with each supplier in response to changes in the demand for a product.

The present invention is particularly useful for a product with varying demand. It is nearly impossible to be constantly updating each order for materials with numerous suppliers using a manual process.

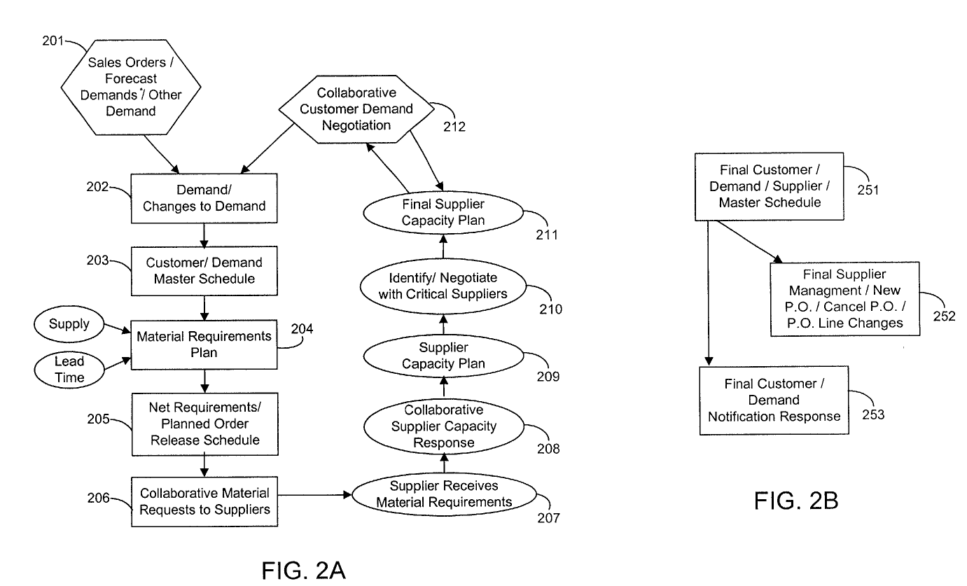

FIG. 2A illustrates steps involved in negotiating purchase orders for materials between a manufacturer and suppliers. The system of the present invention calculates demand for a product to be built by a manufacturer based on customer orders 201 input into the system. A customer 101 may request that the products be built according to specific requirements.

A manufacturer may also build a quantity of its products without waiting for customers to order them. The total demand for each a product can be based on a model of forecasted demand 201 for the product over time (in addition to, or instead of, specific customer orders). The demand for a product may also include forecast demand for spare parts for the product over time. Alternatively, the demand for a product or spare parts can be based upon data that is received from an internal computer system such as an Materials Resource Planning (MRP) system. MRP systems are well-known to those of skill in the art. The demand data for a product can be stored on a database (e.g., a database maintained by IWBCE 108).

The demand for a product or spare parts can change over time when customers requirements change or when a forecast demand changes. For example, a customer may request that a ship date of a purchase order be moved to an earlier or a later date. A customer may change the quantity of ordered products to a higher or a lower amount. A customer may also split an order. For example, an order for 50 units on a single date may be subsequently split into different amounts on different dates. Demand can also change when the forecast demand for the product or spare parts changes. For example, the forecast demand for a product can decrease during an industry recession.

At step 202 in FIG. 2A, the system of the present invention receives data indicating the demand for production of a product and changes to that demand in real-time. For example, a customer can enter a purchase order for a product by accessing IWBCE 108 over the Internet. The customer can enter purchase order information such as a quantity and delivery dates into a database maintained by IWBCE 108. Software of the present invention can then calculate an updated demand schedule for the product. The present invention can quickly negotiate and renegotiate purchase orders with suppliers in response to the current demand for a product so that carry costs for inventories of materials are minimized.

At step 203 in FIG. 2A, the system of the present invention accepts all of the demand input for a product and creates a complete schedule of spare parts and products that the manufacturer must produce over time. The schedule is referred to as a Customer/Demand Master Schedule. The Customer/Demand Master Schedule models demand for a product as discrete increments or as a continuous process flow. In a continuous demand model, the demand is the supply of a product required per discrete time increment. As the time increments become small enough, the continuous demand model becomes equivalent to the discrete demand model. For example, the demand for 60 motors per hour is equal to the production of one motor per minute in a production line.

At step 204 in FIG. 2A, the system calculates a material requirements plan. A material requirements plan indicates the quantity of materials required to implement the Customer/Demand Master Schedule. The material requirements plan can include quantities of new materials, semi-finished materials, subassemblies, assembly modules, parts, raw materials, and other components. The material requirements plan calculates the gross requirements for a material by comparing the available supply of the material to the demand for the product and spare parts that include the material.

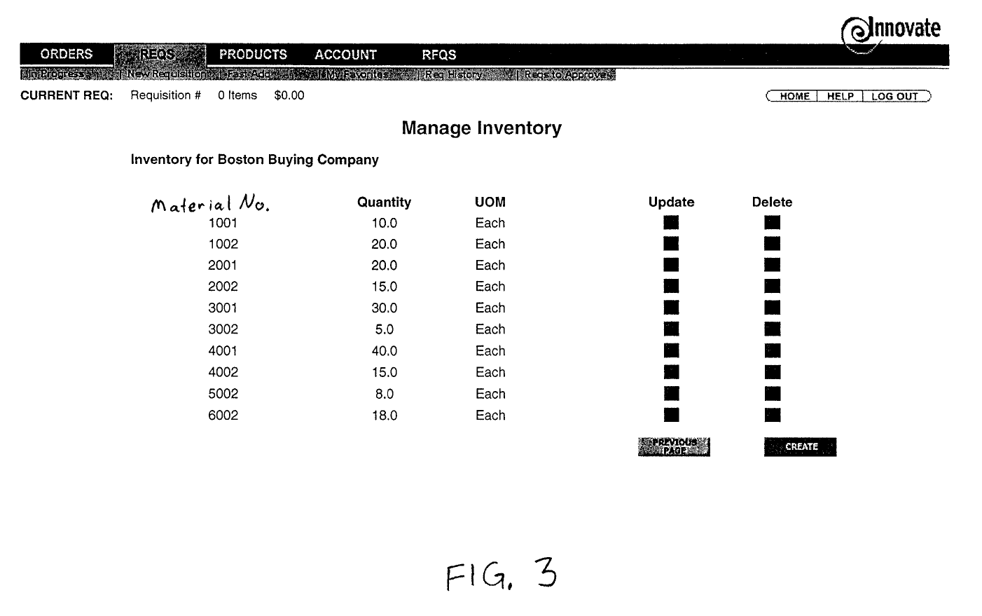

FIG. 3 illustrates an example of an available inventory of materials at an OEM (i.e., materials the OEM has in-stock). The inventory can be stored on a database maintained by IWBCE 108. The inventory can be displayed to an OEM user as shown in FIG. 3. UOM stands for unit of materials. An OEM user can update or delete information related to the materials.

A quantity of each material needed to build enough products to meet the demand can also be displayed to the user. The OEM may already have some of these materials in stock. The material requirements plan can also include information regarding materials in-stock.

Further details on the sources of supply of a material are now discussed. There are many types of supply including an OEM's current inventory, materials on order, materials committed to be purchased over time (e.g., a one year blanket order for 100 units), outside available supply from vendors, and new supply that can be created through quoting and purchase orders with vendors. Each type of supply has a different level of commitment and flexibility with the OEM.

The system of the present invention can obtain information on the supply of a material from a number of sources in real-time or near real-time. Supply is obtained through information links with internal systems and with outside vendors. The system can be linked to internal databases (e.g., through a local area network) to gather and update information on current inventory and materials on order, but not yet received. The system can also be linked with outside suppliers to gather and update data indicating the available supply of materials and any potential new supplies. The links allow fully automatic, semi-automatic, or human intervention to provide the updates. For example, the links may comprise Internet communication links such as e-mail or the transmission of documents over the Internet.

Supply can be presented as a capacity model for either an internal or external process. This model can be used to calculate the amount of supply that can be produced in a certain time increment. For example, a plan can produce 60 motors per hour or 1 motor per minute. Supply can be presented as a pure discrete capacity or by modeling a continuous process as a discrete capacity per time increment. The supplier can be directly linked, and through a contractual agreement, a supplier can operate on an open blanket order to produce to the requirements of the OEM or customer.

The material requirements plan uses information from a Bill of Attributes for a product. A Bill of Attributes is a data repository that contains all the information for a product including design, production, customer service, and field service information. A Bill of Attributes usually contains a complete history for the product. A Bill of Materials is a subset of information of a product that contains the list of materials used to build the product, the lead time required to build or procure the materials (more details on lead time below), the relationship to other materials or assemblies in the product, and other relevant information relating to the materials for a product.

The material requirements plan uses the Customer/Demand Master Schedule and the Bill of Materials to calculate a component materials plan for a product. A component materials plan indicates the gross requirements for the materials needed to build the product over a period of time. The component materials plan indicates the net requirements for the materials and a planned order release schedule for the materials, which is discussed farther below in step 205.

The material requirements plan and the component materials plan may take into account the lead time required to build or procure the materials and the interrelationships among the materials. The lead time to obtain a material is critical. Lead time can be manually input as a single static number assigned to all material obtained from a single source or multiple sources.

Systems using the present invention can obtain information on lead time from a number of sources in real-time or near real-time including suppliers. Lead time can be made of a number of data components including, but not limited to, design time, raw material procurement time, fabrication time, assembly time, testing time, shipping time, and others time constraints. Internal changes to lead time could, for example, be due to a machine breakdown or an increase in demand that creates a scarcity of internal labor. External changes in lead time could include, for example, an impact on shipping time due to poor whether conditions or overall poor economic conditions that create excess capacity.

Systems using the present invention can automatically update the lead time for materials by periodically obtaining lead time data components from internal databases and outside suppliers using various communication links. Systems using the present invention can update lead time on a regular basis by collaborating with suppliers without placing an order or quoting a product. For example, systems using the present invention can periodically check a database to obtain updated information on a supplier's stock of a particular material.

There are typically two lead time components associated with each material. Assembly lead time for a material is the lead time required for the manufacturer to assemble the product after the material has been received. Purchasing lead time is the time required to receive a material from a supplier of that material. This lead time is dependent on the supplier's capacity to produce and deliver the material.

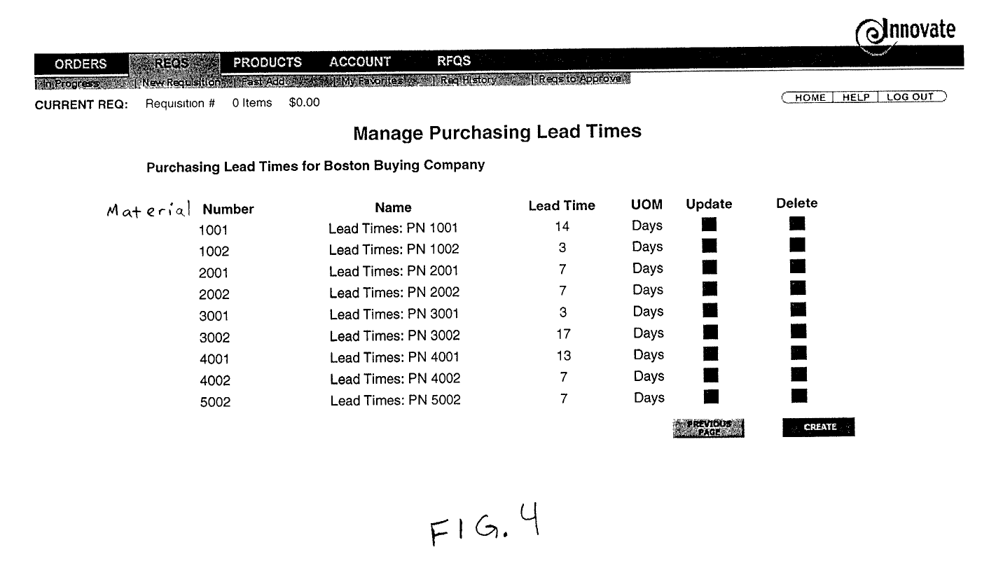

FIG. 4 displays a list of materials and a purchasing lead time in days (UOM) for each material. The information shown in FIG. 4 can be maintained in a database. An OEM user can access the purchasing lead times and the assembly lead times for materials needed to build a product from a database maintained by IWBCE 108. The OEM user then can update or delete any of the lead time information.

Systems of the present invention can also employ variable lead times for a product or a material to calculate a component materials plan. A variable lead time can vary for different reasons. For example, lead time may vary by changing the types of supply for a material (e.g., using a different supplier) or the particular lots from a supplier with which the lead time is associated. Suppliers may periodically update lead times for their materials in a database based upon their capacity and current turn around time. Databases residing on IWBCE 108 can access information from other databases to determine a supplier's current lead time.

A dynamic lead time across each set of material requirements can be applied. A dynamic lead time for a material changes in real-time or near real-time by using a collaborative Internet based system (or other electronic or manual information collection system).

Lead time can also be presented as a discrete increment or by modeling a continuous process as a discrete capacity per time increment. Lead time then is a set number of discrete volume per time increment. For example, the production of one motor per minute causes a lead time per motor of one minute in a production line. In a continuous conveyor system of coal, the process can be represented as a discrete set of inputs, enabling a continuous flow of 600 lbs. per hour of load to be represented by a lead time and supply model that characterizes the process as 10 lbs. of coal with a one minute lead time.

As indicated above, the component materials plan calculates a set of net requirements for the materials needed to build a quantity of a product, and a planned order release schedule for the materials at step 205 in FIG. 2A. A planned order release schedule lays out dates (or date ranges) when specific quantities of materials must be received by the manufacturer to build the products by the customer's deadline. The planned order release schedule is used to implement the production of the product according to the Customer/Demand Master Schedule.

Systems using the present invention allow for automatic, semi-automatic or human decisions on material requirement order levels. For certain types of materials, constraints would be set under which a particular policy is applied. A policy may allow for a purchase order for a quantity of materials to be automatically made available to a supplier or only after human review. Alternatively, different options may be calculated and one option selected by a person.

The planned order release schedule is dependent on the order policy used by the OEM. The OEM can use many types of policies including, but not limited to, orders that are linked to known demand for purchase orders received, build to demand, blanket orders, long lead time order management policy, orders based on a model of economic order quantities, orders based on a certain order point being reached, and others.

Systems using the present invention allow the OEM to select policies based on various factors. OEMs can assign or suggest different policies for different types of materials. The system of the present invention can allow set policies based on total dollar impact or for different purchasing employees.

Systems using the present invention can make comparisons between different policies based on various factors. They can evaluate various effects and trade-offs presented by different policies in terms of risk factors and cost displayed through web based computer systems.

At step 206 in FIG. 2A, a system of the present invention creates requisitions for the materials needed from the suppliers and makes these requisitions available to the suppliers. For example, the requisitions may be available in a database residing on IWBCE 108. Suppliers 103 can download the requisitions onto their web browsers from the database over the Internet. The requisitions may be in the form of a request for a quote on a quantity of materials, or a legal offer to enter into a purchase contract for the materials. Thus, the requisition may or may not constitute a legal offer to form a contract. The requisition may also be in the form of a blanket order to purchase a quantity of materials over an extended period of time (e.g., 18 months), or a release from an existing blanket order.

The requisitions may include requests for a quantity of materials, required delivery dates, prices, and any other issues and relevant information. The requisitions may contain delivery dates, quantities of materials, and other data that is based on information in the planned order release schedule and the component materials plan.

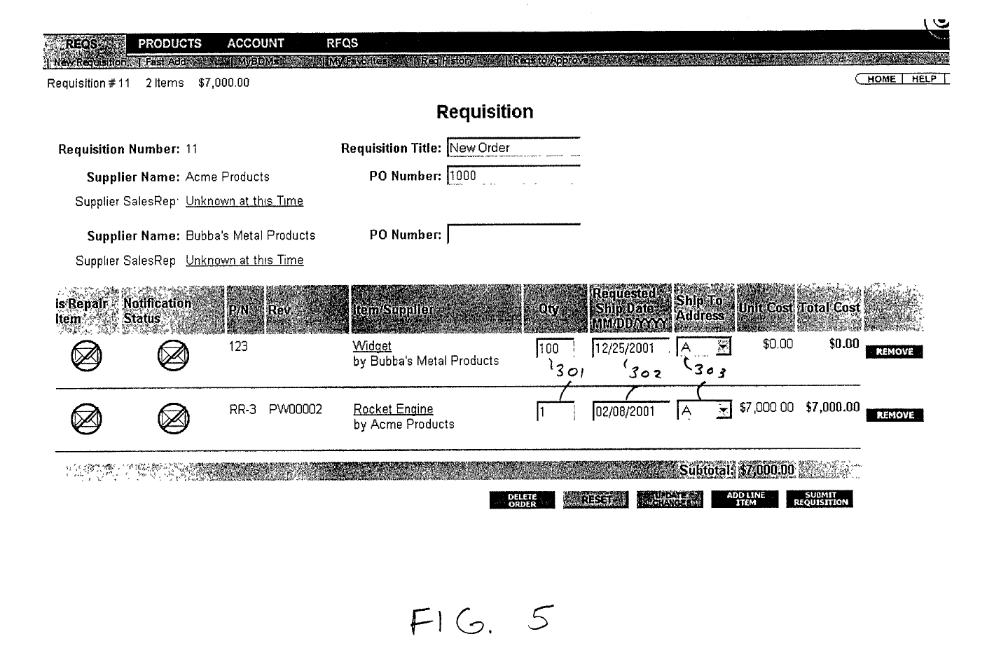

FIG. 5 illustrates an example of an interactive user interface of the present invention. A buyer can use the interactive interface of FIG. 5 to order materials or products from a plurality of sellers. A customer, OEM, or a supplier may use the interface shown in FIG. 5 to order materials or products from a seller. FIG. 5 displays a requisition for two orders of materials (a widget and a rocket engine) from two different suppliers. The requisition may be a purchase order or a request for a quote. The requisition shown in FIG. 5 may be based upon the component materials plan for a product. The requested quantity and the requested ship date may be based upon the planned order release schedule.

Software can automatically enter the data in fields 301-303 (and the cost fields) based upon data in the components materials plan. Alternatively, a buyer can manually enter data into any of the fields in FIG. 5, including a requested quantity (region 301), a requested ship date (region 302), and a shipping address (region 303). The information shown in FIG. 5 that is relevant to each supplier is made available to that supplier (e.g., over the Internet, a WAN or a LAN). Payment information may also be made available to each supplier.

Suppliers can access the requisitions from a database residing on IWBCE 108 over the Internet, a wide area network (WAN), a local area network (LAN), or any other communication system that allows suppliers to download the requisition data. A supplier can be an independent business or a company plant that is internal to the OEM.

Once a requisition is accessible by a seller, the buyer's interface to the database may be locked, preventing the buyer from entering any farther changes to the requisition until the seller has released the requisition. This prevents buyers and sellers from making changes to a requisition at the same time, which may cause redundant records to be formed in databases residing on IWBCE 108.

At step 207 in FIG. 2A, the suppliers receive the requisitions for materials from the buyer OEM through a selected communication medium. For example, a supplier can download a requisition for materials onto a web browser. The requisitions may include purchase orders, requests for quotes, releases, and other information as stated above.

A supplier uses the material requisitions received from the OEM to create a supplier master schedule. A supplier master schedule lays out a schedule for production of a material that meets the demand for the material. The supplier master schedule is used to calculate an internal production plan The supplier's internal production plan lays out the capacity of the supplier to deliver quantities of a requested material over time by evaluating availability of raw materials, inventory, production capacity, labor, etc.

A supplier's master schedule and the internal production plan may be stored in a database. Suppliers may use a software system that embodies the principles of the present invention. The supplier software system can have the same functionality as the OEM software system, including the ability to update demand and to calculate and recalculate a material requirements plan. The supplier software system can be used to negotiate the purchase of materials with its own suppliers 104.

The supplier software systems can calculate a supplier's internal production plan based on demand for its products and the available supply of materials needed to build its products. Alternatively, a Material Requirements Planning (MRP) based system or other planning tool can generate the supplier's internal production plan.

At step 208, the supplier enters information into a database indicating the supplier's capacity to deliver the request materials. The supplier can respond to the requisition by agreeing to the terms of the requisition. A legal contract may or may not be formed at this time. The supplier can also respond to the requisition by entering different delivery dates, prices, or quantities of materials into the database. This may constitute a counter offer to the buyer or a quote. Supplier can, for example, add data to the database through a web enabled interface or through an intranet interface.

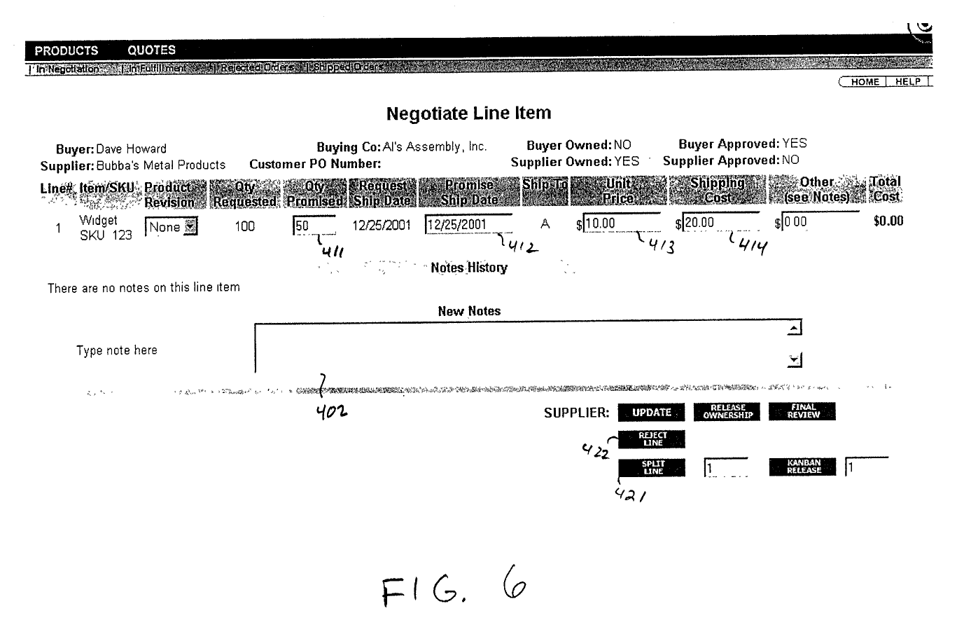

FIG. 6 illustrates an example of an interactive interface of the present invention provided to a seller (e.g., a supplier). The user interface of FIG. 6 illustrates a requisition order displayed to a seller. The seller can enter a promised quantity of a material (region 411), a shipping date (region 412), a unit price (region 413), and a shipping cost (region 414) based upon the seller's capacity to deliver the requested materials. If a supplier cannot deliver a portion or all of the materials on the date requested, the supplier can enter a different quantity or different ship date based upon its capacity. The supplier can also enter a different price than the price requested by the buyer.

In another embodiment, the supplier's software system may automatically enter a quantity, a ship date, a unit price, and a shipping price in the fields shown in FIG. 6 based upon the supplier's capacity and its internal production plan using, for example, XML (extensible mark-up language). The software can determine if and when a supplier will have the available capacity to fulfill the requisition by accessing capacity data. The software can automatically send data to a database by filling in fields 411-414 after analyzing the supplier's capacity data obtained from a database. The databases may, for example, be maintained by IWBCE 108. A supplier's XML software can automatically respond to orders for materials on a first come, first serve basis.

The supplier's response can be in collaboration with the buyer's request and may include reasons for the supplier's response and other alternatives available outside the specific ship dates requested by the buyer/OEM. These reasons and comments can be entered in the screen shown in FIG. 6 in region 402.

The supplier can accept all of the terms of the requisition or enter alternative terms. The supplier can also split the requested order by selecting the split line option 421 in FIG. 6. For example, if the OEM requested 100 units of part B on June 10^{th}, the supplier can respond with an offer to deliver 50 units on June 10^{th} and 50 units on June 19^{th}. The supplier can also reject the order entirely (option 422) or approve the order in its original form. The information entered into the user interface of FIG. 6 is stored in a database. Once a seller releases a requisition, the seller's interface to the database may lock up, preventing the seller from entering any further changes to the requisition until the buyer has released the requisition again.

A software system then aggregates the responses received from all of the suppliers that are needed to supply materials to meet the demand for a product. At step 209 in FIG. 2A, the software system of the present invention calculates a total Supplier Capacity Plan using a planning algorithm. The planning algorithm accumulates the responses from all of the suppliers and identifies changes suppliers have made to the original requisitions. The Supplier Capacity Plan is a schedule of delivery dates, quantities, and other information for the materials that is based on the capacity information provided by the suppliers in their responses to the requisitions.

The total planning algorithm calculates the impact on the component materials plan and the Customer/Demand Master Schedule caused by changes to the requisitions made by the suppliers. For example, data in the Supplier Capacity Plan may indicate that the timing of the Customer/Demand Master Schedule has to be pushed out to a later date if one or more critical suppliers cannot deliver materials within a particular time period. The system calculates a new delivery schedule that indicates new delivery dates for all of the materials. The new delivery schedule can push out delivery dates for all of the materials to later dates to reduce the manufacturer's carrying costs. The later delivery dates are based on the capacity of the critical suppliers to deliver their portions of the materials and the lead times for all of the materials.

The Supplier Capacity Plan may show various feasible dates for each entry in the components materials plan (and the Customer/Demand Master Schedule). Feasible dates may be based, for example, on customer flexibility or lead time flexibility.

At step 209, the software system also calculates a new Supplier Master Schedule that determines the available delivery dates of the customer products based on the constraints imposed by the available capacities of all the suppliers. For example, the delivery dates of a quantity of the products may be pushed out to a later date, in response to delivery constraints imposed by the critical suppliers. The system uses the delivery dates provided by the suppliers for the various materials and the dependencies of the product's Bill of Materials to determine a feasible Customer/Demand Master Schedule.

The interdependencies of the product's Bill of Materials indicates the relationships between materials in a product and the lead time to procure a material. For example, some materials may have to be received sooner than others to begin the production of a product. Therefore, the fact that some materials arrive later than others does not necessarily delay a production schedule.

At step 210 in FIG. 2A, the software system identifies the critical suppliers that cannot meet the originally requested requirements. For example, the system can identify the suppliers that cannot deliver the requested quantity of materials within the time frame specified in the original component materials plan (and the Customer/Demand Master Schedule). The system may also determine which suppliers cannot produce and deliver requested materials within a particular cost limit and which suppliers cannot produce requested materials according to particular design and operation requirements. The design and operation requirements may be customized for a particular customer or specific to the OEM.

At step 210, the OEM system can negotiate different options with the critical suppliers. The OEM's software system can review any alternative options presented by suppliers to the OEM in response to changes in a requisition and can identify the most cost effective options. The OEM's system may take into account any or all of the OEM's company policies with respect to handling supplier options. In addition, the OEM's system can respond to the critical suppliers with further alternative plans to develop options for the Customer/Demand Master Schedule (e.g., 50 units on June 10^{th} and 50 units on June 19^{th}).

Once the terms of the requisition orders with the critical suppliers have been agreed upon by both the OEM and the critical suppliers, software calculates changes to the requisitions with all of the other suppliers based upon the Supplier Capacity Plan. The changes to the requisitions are designed to reduce the carrying costs of materials (e.g., by requesting later delivery dates for non-critical materials). Updated requisitions are then created and released to all of the suppliers. The suppliers may be notified through e-mail, fax, or other means that the terms of the original requisition orders have been altered. The updated requisitions may include new delivery dates and/or new quantities of materials. The suppliers can access the updated requisitions from a database.

The suppliers can then recalculate their own Supplier Master Schedules and internal production plans based upon the updated requisitions. A supplier can communicate with its suppliers to evaluate the feasibility of the OEM's alternative plan. At each step of collaboration between the OEM and a supplier, a supplier enters new data into a database indicating its capacity, and, in response, software recalculates a new Supplier Capacity Plan and then releases updated requisitions. The suppliers can download the updated requisitions by accessing the database.

Once the OEM and all the suppliers have collaborated and developed the best Supplier Capacity Plan, the system calculates the Final Supplier Capacity Plan based on the best capacity that the suppliers are able to deliver at step 211 in FIG. 2A. The Final Supplier Capacity Plan is a schedule for the delivery of the materials needed to build the products that all the suppliers have actually agreed to. The Final Supplier Capacity Plan is in accord with the ability of each supplier to provide the required materials in an agreed upon time frame.

The Final Supplier Capacity Plan is designed to reduce the quantity of materials that the OEM has to carry before production on the products can begin and the amount of time the OEM has to carry the materials. By reducing the inventory carrying time for the materials, the present invention can provide significant cost savings to OEMs as well as suppliers.

The system then updates the Customer/Demand Master Schedule based on the Final Supplier Capacity Plan. The schedule of materials and products presented in the Customer/Demand Master Schedule now matches the schedule in the Final Supplier Capacity Plan.

Next the system compares the changes in the Customer/Demand Master Schedule to the purchase orders requested by the customer. At step 212, the system of the present invention negotiates the terms of the revised sales orders with the customer. The negotiations may take place through the Internet. For example, the system can send a notification message to customer 101 indicating that there are changes to the purchase order. Customer 101 can then download details of the new schedule for its purchase order from a database on a web browser (or other application). The customer can then reject the revised purchase order, accept it, or any make further changes.

If the customer does not accept the revised schedule for the purchase order of the products, the OEM may cancel the purchase order, or attempt to negotiate another order schedule for the product and go through another round of negotiations with its suppliers. If the OEM renegotiates another order schedule with the customer, the OEM system returns to step 202 (FIG. 2A) to begin to develop a new Customer/Demand Master Schedule. The process then repeats itself.

When the OEM, the suppliers, and the customers have all agreed on a plan to build the products, the parties indicate their approval of the final plan (e.g., through an option on an interactive interface). The system of the present invention then takes the agreed upon plan and calculates a Final Customer/Demand/Supplier Master (FCDSM) Schedule at step 251 as shown in FIG. 2B. The FCDSM Schedule is accessible by both the suppliers and the customer (e.g., over the Internet). The FCDSM Schedule lays out the delivery schedules of the materials needed for the ordered products, a production schedule for the fabrication of the products, and a delivery schedule to the customer. The FCDSM Schedule is based on terms of finalized requisitions for the purchase of products and materials that the customer, the OEM, and the suppliers have agreed to. The OEM can use the FCDSM Schedule to regulate the production of the ordered products. The FCDSM Schedule and any of the other plans or schedules of the present invention can be printed out at any time.

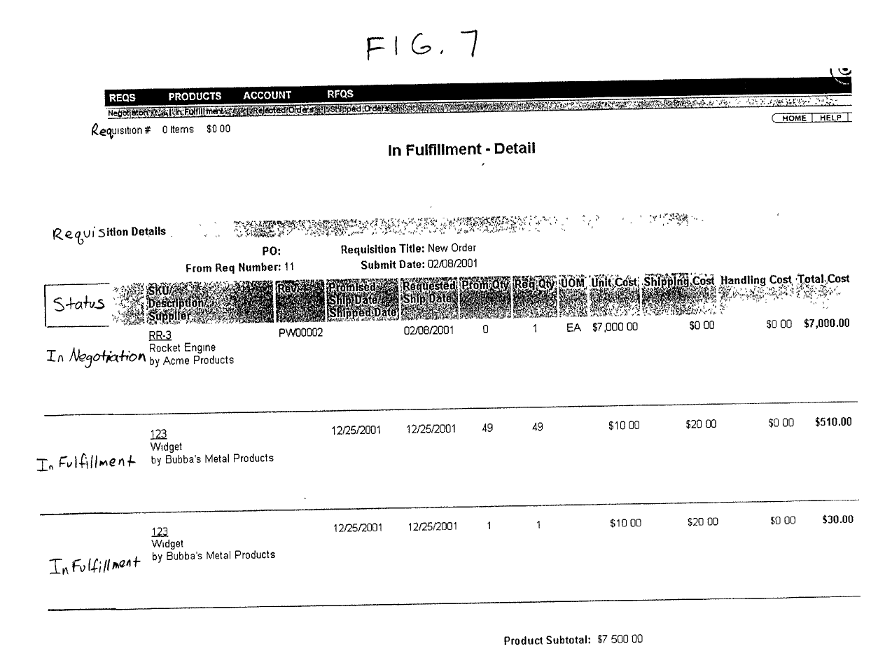

FIG. 7 illustrates an example of a user interface of the present invention that displays a summary of requisition orders that are finalized (i.e., In-Fulfillment) and requisition orders that are still being negotiated with a supplier. The user interface of FIG. 7 is displayed to the OEM. Once the requisitions with all of the suppliers are In-Fulfillment and the customer has agreed to any changes to its original order, the OEM system calculates the FCDSM Schedule. The customer 101 can access information summarizing the order from a database (such as the cost and a new delivery schedule).

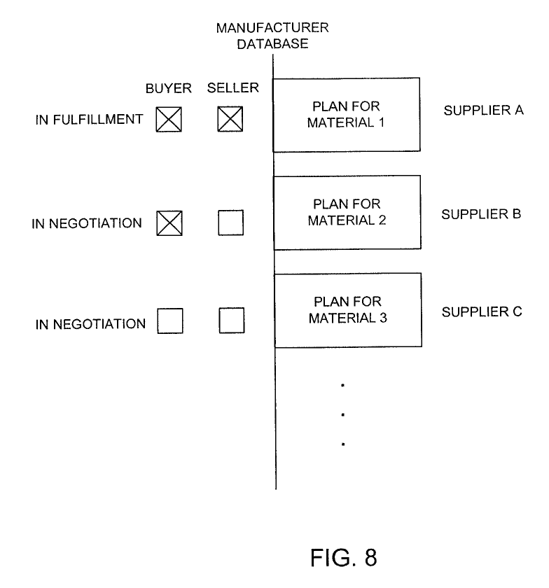

FIG. 8 illustrates a diagram of how the component materials plan is distributed to the suppliers. The components materials plan is used to create one or more requisitions for each of suppliers 103. Suppliers 103 can access their requisitions from a database. For example, supplier A can view a requisition for material 1. Seller A can indicate whether it agrees to all the terms of the requisition. This requisition is then released back to the buyer so that the buyer can the confirm the requisition. If the buyer confirms the order, the order is in fulfillment. The buyer may not want to confirm the requisition if the demand for the product has changed. If seller B does not confirm the requisition for material 2, then this requisition remains in negotiation until all of the terms of this requisition are agreed to by both parties.

At step 252 in FIG. 2B, the suppliers can access the finalized requisition orders from a database. A finalized requisition may, for example, be in the form of a new purchase order, a canceled purchase order, or a line change to an existing purchase order (e.g., a date change, quantity change, or split of an existing line item). The supplier may then be given an opportunity to finalize the requisitions for the materials.

At step 253, the customer 101 can access the finalized sales orders and the demand response schedule from a database. The finalized sales orders have been agreed to by the customer and the OEM. The demand response schedule indicates the dates that the OEM promises to deliver particular quantities of products to the customer (and other relevant information). The system may provide customer 101 with an opportunity to confirm the final sales orders and the delivery schedule.

After a sales order has been finalized, a customer's requirements may change. For example, a customer may require that a product be delivered on a different date, or a customer may change the quantity of products ordered. Demand can also change when a market forecast demand for a product changes.

Changes to the demand for the product (e.g., based on the customer's new requirements) are inputted at step 202 as discussed above. The process discussed above with respect to FIGS. 2A-2B is then repeated to modify the terms of the purchase orders of materials from the suppliers. The delivery dates and quantities of materials ordered from the suppliers are renegotiated using the system of the present invention to reflect the new demand for the product. The present invention responds quickly to changes in demand by renegotiating orders for materials with the suppliers to reduce the OEM's carrying costs for the materials. If demand for a product increases, the present invention provides an efficient system for ordering more materials so that production can ramp up as soon as possible, increasing an OEM's revenue.

While the present invention has been described herein with reference to particular embodiments thereof, a latitude of modification, various changes, and substitutions are intended in the present invention. In some instances, features of the invention can be employed without a corresponding use of other features, without departing from the scope of the invention as set forth. Therefore, many modifications may be made to adapt a particular configuration or method disclosed, without departing from the essential scope and spirit of the present invention. It is intended that the invention not be limited to the particular embodiment disclosed, but that the invention will include all embodiments and equivalents falling within the scope of the claims.

What is claimed is:

1. A method for facilitating negotiations for purchasing materials between a buyer and a plurality of sellers, the method comprising:
calculating a first plan for a set of materials based on a demand for a product, the first plan indicating at least first quantities of the materials needed to build the product;
releasing a portion of the first plan to each of the plurality of sellers;
receiving data relating to the first plan for the set of materials from at least one of the plurality of sellers; and
calculating a second revised plan for the set of materials in response to the data from at least one of the plurality of sellers, the second revised plan indicating new data compared to the first plan, the new data relating to quantities of the materials, delivery dates for the materials, or a price for the materials.

2. The method of claim 1 further comprising:
releasing the second revised plan to the sellers,
wherein each of the of sellers only has access to the portion of the second revised plan relating to the materials being ordered from that seller.

3. The method of claim 1 further comprising:
providing the buyer with an opportunity to enter data relating to the demand.

4. The method of claim 1 wherein calculating the second revised plan for the set of materials further comprises identifying critical suppliers among the sellers that cannot deliver a subset of the materials according to the first plan, and calculating the second revised plan in response to data from the critical suppliers.

5. The method of claim 4 further comprising:
releasing a portion of the second revised plan to a subset of the sellers that comprise non-critical suppliers,
wherein the portion of the second revised plan released to the non-critical suppliers includes delivery dates that are selected based upon delivery dates provided by the critical suppliers.

6. The method of claim 1 further comprising:
calculating a third revised plan for the set of materials in response to changes in the demand for the product, the third revised plan comprising a second set of new data compared to the second revised plan, the second set of new data relating to quantities of the materials, delivery dates for the materials, or a price for the materials; and
releasing the third revised plan to the plurality of sellers.

7. The method of claim 6 wherein the demand is based at least in part on a forecast demand for the product; and wherein the changes in the demand occur in response to changes in the forecast demand for the product.

8. The method of claim 6 wherein the demand is based at least in part on orders from particular customers, and wherein the changes in the demand occur in response to changes made in the customer orders.

9. The method of claim 1 wherein calculating the first plan for the set of materials further comprises calculating the first quantities of the materials by comparing supplies of the materials to the demand for the product, and wherein the first plan indicates first delivery dates for the materials that factor in a lead time for each of the materials.

10. The method of claim 9 wherein calculating the second revised plan for the set of materials further comprises calculating second revised delivery dates for the materials in response to the data from the seller.

11. The method of claim 9 wherein calculating the first plan for the set of materials further comprises taking into account a variable lead time for at least a subset of the materials.

12. The method of claim 9 wherein calculating the second revised plan for the set of materials further comprises calculating second revised quantities for the materials in response to the data from the seller.

13. A system for facilitating negotiations for purchasing materials between a buyer and a plurality of sellers, the system comprising:
a first database that stores a first quantity of each of the materials needed to build a quantity of a product that meets a demand for the product and a first set of dates for the sellers to deliver the materials on a computer system;
wherein the database allows the sellers to access the first quantity of materials and the first set of dates;
the first database receiving data from the sellers indicating an ability of each of the subset of the sellers to deliver a portion of the first quantity of materials on one of the first set of dates;
wherein the computer system determines whether the sellers can deliver the first quantity of each of the materials by the first set of dates.

14. The system of claim 13 wherein the first computer system calculates a second set of dates for the sellers to deliver the materials based upon the data from sellers indicating that at least one of the sellers cannot deliver a portion of the first quantity of materials by the one of the first set of dates, and
wherein the first database releases the second set of dates to the suppliers.

15. The system of claim 13 further comprising a second database accessible by one of the sellers that stores a second quantity of materials needed to build one of the first quantity of materials and a second set of delivery dates.

16. The system of claim 15 wherein the second database allows a second plurality of sellers to access the second quantity of materials;
the second database receiving data from the second plurality of sellers indicating an ability of each of the second plurality of sellers to deliver a portion of the second quantity of materials by the second set of delivery dates.

17. The system of claim 13 wherein the first computer system updates the first quantity of materials needed to build the quantity of the product and the first set of dates for the suppliers to deliver the materials in response to changes in the demand for the product.

18. The system of claim 17 wherein the demand for the product is based upon a forecast demand for the product over time and orders from customers.

19. The system of claim 13 wherein the first computer system determines the first quantity of each of the materials by comparing an available supply of the materials to the demand for the product.

20. The system of claim 13 wherein the first computer system determines a the first set of dates by taking into account a lead time for each of the materials.

21. The method of claim 20 wherein the first computer system updates the first set of dates in response to a variable lead time for at least one of the materials.

22. A method for negotiating orders for materials between a buyer of the materials and a plurality of sellers of the materials, the method comprising:
calculating a first plan for a set of materials based on a demand for a product, the first plan indicating first quantities of the materials needed to build the product and first delivery dates for the materials;
allowing the plurality of sellers to access a first database that stores the first quantities of the materials and the first delivery dates;
receiving data from the sellers indicating an ability of the sellers to deliver the first quantities of the materials by the first delivery dates;
storing the data from the sellers in the first database or a second database;
calculating a second revised plan for the set of materials if the data from the sellers indicates that at least one of the sellers cannot deliver a portion of the first quantities of the materials by one of the first delivery dates, the second revised plan indicating second revised delivery dates for the materials; and
releasing the second revised delivery dates to the sellers.

23. The method of claim 22 further comprising:
calculating a third revised plan for the set of materials in response to changes in the demand for the product, the third revised plan comprising second revised quantities of the materials or third revised delivery dates for the materials; and
releasing at least a portion of the third revised plan to the plurality of sellers.

24. The method of claim 22 further comprising:
if the data from the sellers indicates that all of the sellers can deliver the first quantities of the materials by the first delivery dates, releasing data to a buyer of the product indicating a delivery date for a quantity of the product ordered by the buyer of the product.
